(19) United States
(12) Patent Application Publication
(10) Pub. No.: US 2006/0012833 A1
(43) Pub. Date: Jan. 19, 2006

(54) Image scanning apparatus

(75) Inventors: Shuichi Ito, Zama-shi (JP); Tomoyuki Ishii, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Konica Minolta Business Technologies, Inc., Tokyo (JP)

(21) Appl. No.: 11/042,895

(22) Filed: Jan. 25, 2005

(30) Foreign Application Priority Data
Jul. 15, 2004 (JP) JP2004-208133
Nov. 4, 2004 (JP) JP2004-321182

(51) Int. Cl. H04N 1/00

(52) U.S. Cl. 358/400; 358/474; 358/402

(57) ABSTRACT

An image scanning apparatus includes a reader which reads an original document in accordance with a first reading condition and generates a first image data corresponding to the original document, a processor which calculates a first calculated value relating to a first attribution of the first image data and a second supposed value based on a second reading condition different from the first reading condition and one of the first image data and the first calculated value, wherein the second supposed value relates to a second attribution, and the second attribution relates to a second image data which are generated in case the original document, is read in accordance with the second reading condition, and a display which displays the first calculated value and the second supposed value.

### RELATED APPLICATION

This application is based on patent applications Nos. Tokugan 2004-321182 filed in Japan, the entire content of which is hereby incorporated by reference.

### BACKGROUND

1. Field of the Invention

The present invention relates to an image scanning apparatus for reading original documents.

2. Description of the Related Art

There are image scanning apparatuses having functions to store image data obtained by reading an original document into a file, and to transmit the file attached to an electronic mail or transmit the file to an external device via networks. On such an apparatus, various solutions are taken so that no heavy load is placed on networks due to a large amount of transmitted data.

For example, in cases where data size exceeds a predetermined upper limit, some image scanning apparatuses automatically reduce data size by decreasing resolution or reducing image size (for example, see Patent Document 1). Also, image scanning apparatuses are offered which automatically select a compression method, depending on data size (for example, see Patent Document 2).
[Patent Document 1] TOKKAI No. 2003-16017
[Patent Document 2] TOKKAI No. 2000-101795

An apparatus which automatically changes resolution, image size, and compression method, according to data size, makes such a change without confirming user's intention. Consequently, sometimes, an image is transmitted which has an image quality undesired by the user. For example, in a case where the user prioritizes image quality, even sacrificing a little increase in the network load, it has been impossible to reflect such a desire by the user.

On the other hand, the user does not know to what extent data size and load on the network change when resolution or compression method is changed, and accordingly, the user can hardly select optimum reading conditions.

### SUMMARY

To solve the above problem, an object of the invention is to provide a user with information for determination allowing the user to select proper reading conditions of transmission, and to provide an image scanning apparatus on which the user himself/herself can select reading conditions based on this information for determination.

(1) An image scanning apparatus includes a reader which reads an original document, a detector which detects a calculated value relating to an attribution of a data read by the reader, a processor which performs calculation on the data having been read by the reader to obtain a supposed value relating to the attribution of a data after changing a reading condition of reading the original document, and a display which displays the calculated value and the supposed value.

According to above item (1), a display displays a calculated value relating to a predetermined attribution of a data obtained by reading an original document and a supposed value in a case of changing a reading condition. A single supposed value may be obtained, and a plurality of supposed values may also be obtained by changing the reading condition in various ways.

(2) An image scanning apparatus includes a reader which reads an original document, a first detector which detects a first calculated value relating to an attribute of a data read by the reader in accordance with a first reading condition, a second detector which detects a second calculated value relating to the attribute of a data read by the reader in accordance with a second reading condition different from the first reading condition, and a display which displays the first calculated value and the second calculated value.

According to above item (2), the same original document is read plural times in accordance with different conditions, and calculated values relating to a predetermined attribution are displayed for data obtained by the respective readings.

(3) An image scanning apparatus comprises a reader which reads an original document, a detector which detects a calculated value relating to an attribution of a data read by the reader, a processor which calculates a supposed value relating to the attribution of the data read by the reader in accordance with an output condition for output of the data, and a display which displays the calculated value and the supposed value.

According to above item (3), regarding a read data, a calculated value and a supposed value in accordance with an output condition for output are displayed, wherein the calculated value and the supposed value are related to a predetermined attribution. The output condition can be, for example, a recording sheet size for output or a resolution for output.

(4) An image scanning apparatus includes a reader which reads an original document and generates an image signals corresponding to the original document, an image processing condition setting section which is selectable for one of a first processing condition and a second processing condition, a processor which generates a first image data by processing the image signals in accordance with the first processing condition, and calculates a first calculated attribution value based on the first image data, and a display which displays the first calculated attribution value.

(5) An image scanning system includes an image scanning apparatus, a computer electrically connected with the image scanning apparatus, wherein the image scanning apparatus includes a reader which reads an original document and generates an image signals corresponding to the original document, and a processor which generates a first image data by processing the image signals in accordance with a first processing condition, and calculates a first calculated attribution value based on the first image data, and wherein the computer includes a display which displays the first calculated attribution value.

An image scanning apparatus in accordance with the invention displays a calculated value relating to a predetermined attribution of a data obtained by reading an original document, and displays calculated values and supposed values, the calculated values and the supposed values being of a case where a reading condition is changed, or displays supposed values corresponding to output conditions, and thus, a user is provided with information for determination of selection of reading conditions or the like. In this way, the user can select desired reading conditions or output conditions, referring to the displayed calculated value/values and/or supposed value/values. For example, when the calculated value/values and/or supposed value/values are data capacities, the user can select a data with a condition suitable for transmission. Further, when the user knows the network environment on the receiving side, the user himself/herself can select an image data which fits the environment, referring to the calculated and/or supposed values that are displayed.

By obtaining a supposed value, information for determination can be supplied to the user more quickly than a case of obtaining a calculated value by re-reading the original document. On the other hand, by repeating calculation, accurate information for determination can be provided.

By displaying information on transmission loads as well as calculated values and supposed values, even a user who cannot determine only by a data size can be noticed, in a way easy to understand, to what extent a load will be placed on a network.

The invention itself, together with further objects and attendant advantages, will best be understood by reference to the following detailed description taken in conjunction with the accompanying drawings.

### BRIEF DESCRIPTION OF THE DRAWINGS

FIG. 1 is a block diagram showing a structure of an image scanning apparatus in accordance with an embodiment of the present invention and the usage environment of the apparatus;

FIG. 2 is a schematic flowchart showing the operation of the image scanning apparatus;

FIG. 3 is a flowchart showing “Scan to E-mail processing 1” in a case of changing resolution as a reading condition;

FIG. 4 is a diagram showing an example of a display screen categorized by resolution, the display screen being displayed on an operation panel of the image scanning apparatus;

FIG. 5 is a diagram showing an example of the display screen categorized by resolution after changing the resolution;

FIG. 6 is a flowchart showing “Scan to E-mail processing 1” in a case of changing a compression method as a reading condition;

FIG. 7 is a diagram showing an example of a display screen categorized by compression-method, the display screen being displayed on the operation panel of the image scanning apparatus;

FIG. 8 is a diagram showing an example of the display screen categorized by compression-method after changing the compression method;

FIG. 9 is a flowchart showing “Scan to E-mail processing 1” for a case of changing image quality as a reading condition;

FIG. 10 is a diagram showing an example of a display screen categorized by image-quality, the display screen being displayed on the operation panel of the image scanning apparatus;

FIG. 11 is a diagram showing an example of the display screen categorized by image-quality after changing an image quality;

FIG. 12 is a flowchart showing “Scan to E-mail processing 2” in a case of changing resolution as a reading condition;

FIG. 13 is a diagram sowing an example of a weight coefficient table categorized by resolution;

FIG. 14 is a diagram showing an example of the display screen categorized by resolution, the display screen being displayed on the operation panel of the image scanning apparatus;

FIG. 15 is a diagram showing an example of the display screen categorized by resolution after changing the resolution;

FIG. 16 is a flowchart showing “Scan to E-mail processing 2” in a case of changing the compression method as a reading condition;

FIG. 17 is a diagram showing an example of a weight coefficient table categorized by compression-method;

FIG. 18 is a diagram showing an example of the display screen categorized by compression-method, the display screen being displayed on the operation panel of the image scanning apparatus;

FIG. 19 is a diagram showing an example of the display screen categorized by compression-method after changing the compression method;

FIG. 20 is a flowchart showing “Scan to E-mail processing 2” in a case of changing the image quality as a reading condition;

FIG. 21 is a diagram showing an example of the display screen categorized by image-quality, the display screen being displayed on the operation panel of the image scanning apparatus;

FIG. 22 is a diagram showing an example of the display screen categorized by image-quality after changing the image quality;

FIG. 23 is a flowchart showing “Scan to E-mail processing 2” in a case of changing output size as an output condition;

FIG. 24 is a diagram showing an example of a display screen categorized by output-size, the display screen being displayed on the operation panel of the image scanning apparatus;

FIG. 25 is a diagram showing an example of the display screen categorized by output-size after changing the output size;

FIG. 26 is a diagram showing an example of a data display screen in a case of changing the resolution and the compression method;

FIG. 27 is a diagram showing an example of the data display screen after changing the resolution from the state shown in FIG. 26 to 400 dpi;

FIG. 28 is a diagram showing an example of the data display screen in a case of changing the resolution, the image quality, and the compression method; and

FIG. 29 is a diagram showing an example of the data display screen after changing the resolution from the state shown in FIG. 28 to 400 dpi, the image quality to pencil, and the compression method to PDF.

In the following description, like parts are designated by like reference numbers throughout the several drawings.

### DESCRIPTION OF THE PREFERRED EMBODIMENT

An embodiment of the invention will be described below, referring to the drawings.

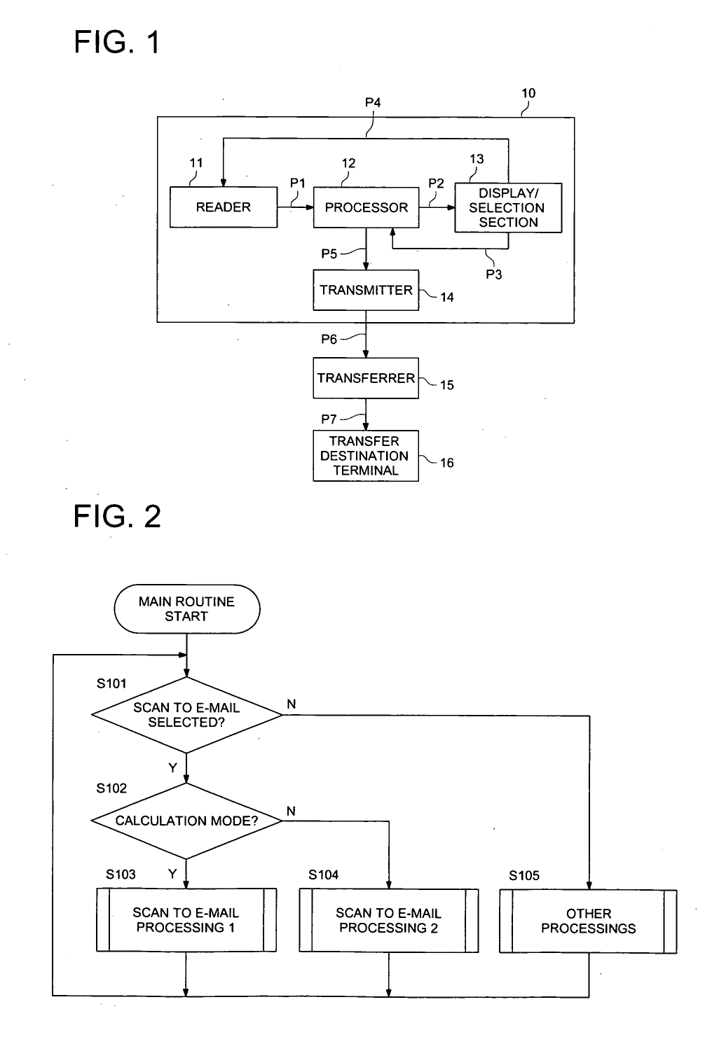

FIG. 1 shows a structure of an image scanning apparatus 10 in accordance with one aspect of the present invention and shows the usage environment of the apparatus. The image scanning apparatus 10 functions to read an original document, thus obtain an image data corresponding to the read original document, store the image data as a file, and transmit the file attached to an electronic mail, or transmit the file to an external terminal by FTP (File Transfer Protocol). As conditions of reading the original document, selection can be made on resolution, image quality, compression method (a file format), and the like.

The image scanning apparatus 10 includes a reader 11, a processor 12, a display/selection section 13 (an operation panel), and a transmitter 14. The image scanning apparatus 10 further includes a storage section, not shown, which temporarily stores image data, and other sections.

The image scanning apparatus 10 is connected to a transfer destination terminal 16 via a transferrer 15. The transferrer 15 is a network or a medium, such as a LAN (local area network), a telephone cable, or an optical cable, which transfers image data having been transmitted. The transfer destination terminal 16 is a device which receives the transferred image data, such as a client PC, a FTP server, or the like.

The reader 11 has a function to read the original document and output image signals corresponding to the read original document. The reader 11 includes, for example, a light source which emitting light onto the original document, a line image sensor which reads the original document for one line in the lateral direction, a mover which moves a reading position in the longitudinal direction of the original document line by line, and an optical system including a lens and/or a mirror which guide(s) reflected light from the original document to the line image sensor to form an image. A CCD (Charge Coupled Device) is employed for the line image sensor. Analogue image signals, output by the line image sensor, are A/D converted to be output as digital image signals.

The processor 12 is configured, having an essential part being a CPU (central processing unit). The processor 12 has a function to perform image processing on the image signals having been output by the reader 11, in accordance with image processing conditions (for example, conditions on reading items such as resolution and compression format and conditions on output items such as output image size) set by an image processing condition setter, not shown, to generate an image data. The processor 12 also has a function to obtain a calculated value relating to a predetermined attribution (for example, data size) of the generated image data, to calculate a supposed value in a case of changing an image processing condition (for example, a reading condition) of the generated image data, and to perform other tasks. With respect to obtaining supposed values, weight coefficients are set in advance for respective conditions on a reading item (for example, each of 400 dpi and 200 dpi on the resolution item). Then, a calculated value relating to an attribution is multiplied by each weight coefficient so that each supposed value is calculated. A supposed value may be calculated based on the image data obtained by image processing. Further, the processor 12 has a function to determine information to be shown to a user, in a way easy to understand, on transfer load in transferring an image data obtained on the basis of an image processing condition having been set by the image processing condition setter. An example is information on a load which will be placed on the network.

The processor 12 may include an image processor which processes on the basis of an image processing condition which is set by the image processing condition setter, and calculator which calculates the attribution value of the image data obtained by the image processor, thus dividing the processing load.

The display/selection section 13 is constructed by a liquid crystal display having a touch panel on a surface and various operation switches, and provided with functions to show the user various guidance displays and status displays, as well as to receive various operational inputs from the user. In detail, in accordance with calculation results of attribution values by the processor 12, the display/selection section 13 displays attribution values (data sizes) for respective reading conditions/output conditions, displays information (information indicating transfer loads) corresponding to respective data sizes and the like, and receives arbitrary selection from displayed image processing conditions for an image data to be transferred. The display/selection section 13 may not be arranged as a unit and have a display section and a selector section, separately. Further, a generated image may be displayed on an external display connected to the image scanning apparatus 10. In the present embodiment, a case has been described, as an example, where the display/selection section 13 is provided on the image scanning apparatus 10. However, the invention is not limited to this example, and a display/selection section 13 may be provided on a computer connected to the image scanning apparatus 10. Further, an image processing condition setter and a display/selection section 13 are arranged as a unit.

The transmitter 14 functions to transmit the generated image data to outside by means of E-mail, FTP, or SMB (Server Message Block), etc. SMB is a network protocol for performing file services, print services, and the like. The transmitter 14 may transmits the image data to a printer, not shown, instead of the transferrer 15.

Further, without being limited to the above example, it is also possible to arrange a scanning system including an image scanning apparatus 10 provided with a reader 11 and a processor 12, and a computer having a display/selection section 13 and being connected to this image scanning apparatus 10. In this case, this scanning system is designed to have a transmitter 14 and to be able to transmit image data to inside and/or outside the scanning system by the use of the transmitter 14.

FIG. 2 shows a schematic operation of the image scanning apparatus 10. If the user sets an original document, selects and sets a type of job, reading conditions, transmitting conditions, and thereafter activates the start button, not shown, then this processing (main routine) is executed. The types of jobs include job “Scan to E-mail” in which an obtained image data is transmitted as an attached file to an E-mail, and other jobs. The other jobs include, for example, a job, in which the obtained image data is transferred, as it is, to a computer.

First, the type of a job is checked (step S101), and if job “Scan to E-mail” is selected (step S101; Y), then it is checked whether a calculation mode is selected (step S102). In job “Scan to E-mail”, the user can select either the calculation mode or a supposition mode. The calculation mode is an operation mode in which the original document is re-read, a reading condition is changed, or image signals obtained by reading the original document are stored and reused, and then the value of a predetermined attribution (for example, data size) of an image data corresponding to each reading condition are obtained. The supposition mode is an operation mode in which the original document is read, an image data and a calculated value relating to a predetermined attribution of the image data are obtained, and then a supposed value in a case of changing a reading condition is obtained by processing the calculated value or the image data.

If the calculation mode is selected (step S102; Y), “Scan to E-mail processing 1” is executed that processor 12 controls to repeat reading the original document plural times, and changing a reading condition each time, and then obtains plural calculated values (step S103). If the supposition mode is selected (step S102; N), “Scan to E-mail processing 2” is executed that processor 12 controls to read the original document and obtains a calculated value, and then obtains a supposed value from the calculated value (step S104). If no “Scan to E-mail” job is selected (step S101; N), then another processing is executed (step S105).

In “Scan to E-mail processing 1”, a calculated value relating to an attribution value for each of plural conditions settable with regard to reading items as image processing conditions are obtained. Namely, in “Scan to E-mail processing 1”, the original document is read and thus image signals are obtained, a plurality of image data are generated in accordance with the image signals and a plurality of image processing conditions, and then calculated values of a predetermined attribution of the respective image data are obtained. For an arbitrary reading item, herein, it is preferable that calculated values are obtained with regard to all the conditions settable on the image scanning apparatus 10. Reading items as image processing conditions include resolution, compression method, and image quality. For example, for resolution, processing conditions such as 600 dpi, 400 dpi, and 200 dpi are settable. In the following, resolution, compression method, and image quality, which are items relating to processing in reading, will be described.

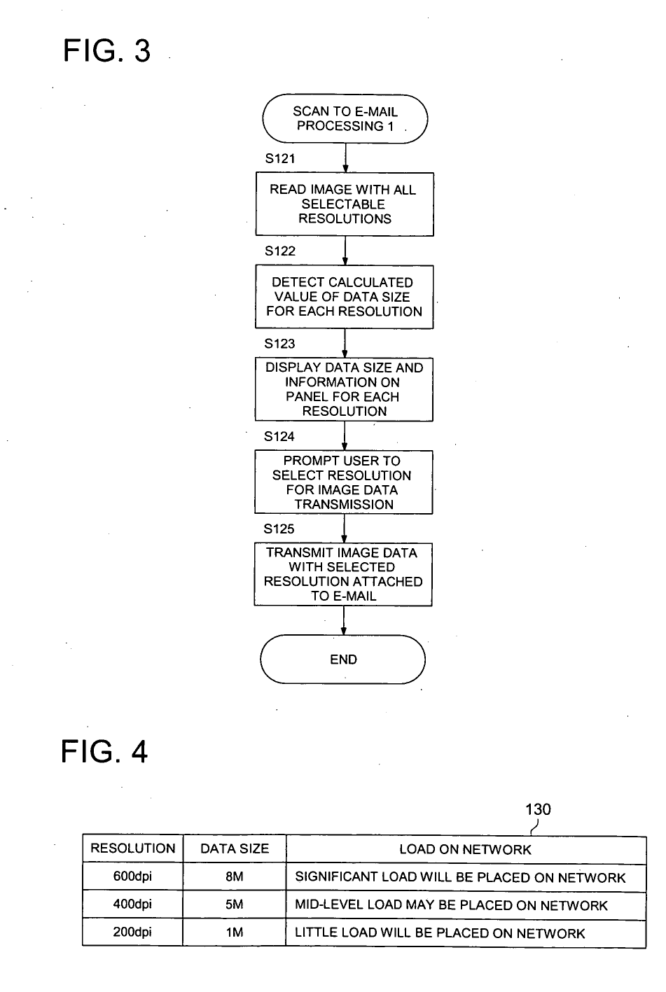

FIG. 3 shows the flow of “Scan to E-mail processing 1” in a case of changing resolution as a reading condition. The original document is read for respective values of resolution selectable on the operation panel 13 to generate respective image data (step S121). For example, if three values of resolution of 600 dpi, 400 dpi, and 200 dpi are selectable on the operation panel 13, reading operations with resolutions set as 600 dpi, 400 dpi, and 200 dpi are executed. In the case of reading the original document with an automated original document feeding device, the user is required to reset the original document on the original document table. In this situation, a message prompting to reset the original document is preferably indicated on the operation panel 13.

Next, respective data sizes (calculated values) are detected from the image data generated with the respective resolutions (step S122), and then the data sizes categorized by resolution and information indicating supposed loads for transfer, of the image data, corresponding to the respective data sizes are displayed on the operation panel 13 (step S123).

FIG. 4 shows an example of a display screen 130 categorized by resolution, the screen being displayed on the operation panel 13. On the display screen 130 categorized by resolution, resolution, data sizes (calculated values), and information indicating supposed loads (loads on the network) for transfer, of the image data, corresponding to the data sizes are correspondingly displayed. Herein, a plurality of types of predetermined thresholds and the data sizes (obtained attribution values) are compared in order to classify the image data, and messages registered in advance corresponding to the respective classes are displayed as information on loads which will be placed on the network for transfer of the image data.

For example, if a data size is less than 3 MB, a message “LITTLE LOAD WILL BE PLACED ON NETWORK” is displayed. If the data size is 3 MB or larger and is smaller than 6 MB, a message “MID-LEVEL LOAD MAY BE PLACED ON NETWORK” is displayed. If the data size is 6 MB or larger, a message “SIGNIFICANT LOAD WILL BE PLACED ON NETWORK” is displayed. Setting of the number of classes, values of the thresholds, and the content of messages can be properly changed.

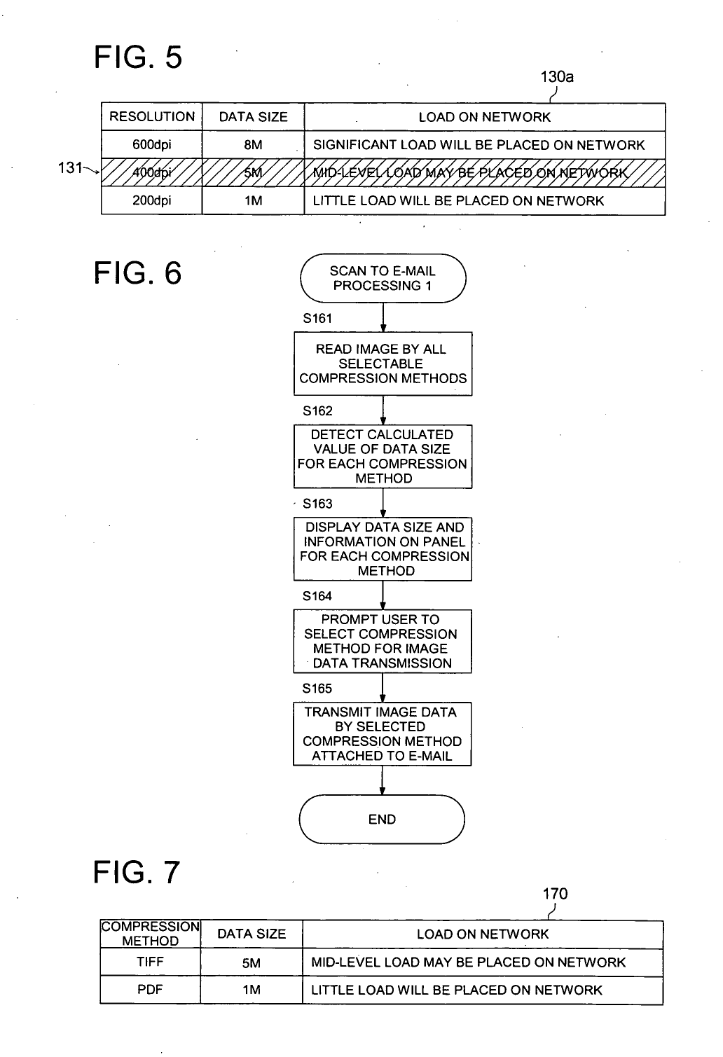

The user is prompted to select a resolution for transmission of an image data, with the display screen 130 categorized by resolution and displayed on the operation panel 13 as information for determination (FIG. 3, step S124). For example, by touching a corresponding position in the display screen 130 categorized by resolution and displayed on the operation panel 13 of a touch panel type, the user can select a resolution. FIG. 5 shows an example of a display screen 130a categorized by resolution in a case where 400 dpi has been selected in FIG. 4. In this screen, the color of a display area 131 of the horizontal line corresponding to the selected resolution is changed. For example, it is possible to make a display by highlighting black and white or by changing the color of the background and texts.

Upon receipt of a resolution selection operation from the user, the image scanning apparatus 10 transmits an image data of the selected resolution, attaching the image data to an E-mail (FIG. 3, step S125).

Next, a case of changing a compression method will be described. FIG. 6 shows the flow of “Scan to E-mail processing 1” in a case of changing a compression method as a reading condition. The original document is read for each compression method selectable on the operation panel 13, and compressed image data are generated (step S161). For example, when two types of compression methods, namely, TIFF (Tagged Image File Format) and PDF (Portable Document Format), are selectable on the operation panel 13, the user changes the compression method to read the original document twice. TIFF and PDF are file formats, and the compression methods used by the respective file formats are different. Therefore, in terms of data size, it means that compression method is virtually selected.

Next, respective data sizes (calculated values) are detected from the image data generated under respective compression-methods (step S162), and for the respective compression methods, the data sizes and information indicating supposed loads for transfer of the respective image data are displayed on the operation panel 13 (step S163).

FIG. 7 shows an example of a display screen 170 categorized by compression-method, the screen being displayed on the operation panel 13. For the respective read image data, the display screen 170 categorized by compression-method correspondingly displays compression methods, data sizes (calculated values), and information indicating supposed loads (being loads on the network) for transfer of the image data, the loads corresponding to the respective data sizes.

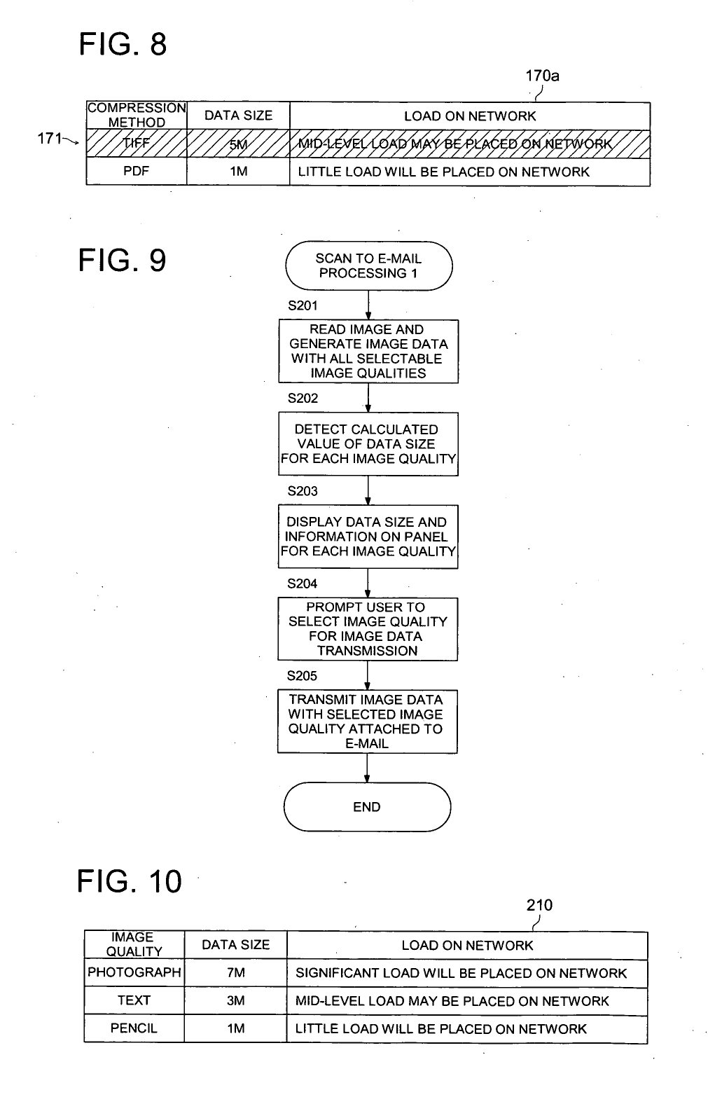

The user is prompted to select a compression method for transmission, with the display screen 170 categorized by compression-method and displayed on the operation panel 13 as information for such determination (FIG. 6, step S164). FIG. 8 shows an example of a display screen 170a categorized by compression-method for the case where TIFF is selected in FIG. 7. In this screen, the color in the display area 171, being a horizontal line, corresponding to the selected compression method is changed. Upon receipt of a selection operation for a compression method from the user, the image scanning apparatus 10 attaches image data by the selected compression method to an E-mail and thereby transmits the image data (FIG. 6, step S165).

Incidentally, the calculated values of data sizes by the respective compression methods may be obtained in such a manner that raw data (image signals) obtained by reading the original document are stored in a memory, and later, compressed image data by the respective compression method are generated from the raw data. In this case, reading operation of the original document is required only once, and thus the working time is shortened. Further, it is not necessary to reset the original document on the automatic original document feeding device, improving the operationability.

Next, a case of changing image quality will be described. FIG. 9 shows the flow of “Scan to E-mail processing 1” for a case of changing a processing mode corresponding to the image quality of the original document as a reading condition. For the respective processing modes corresponding to all the selectable image qualities of the original document, the processing modes being selectable on the operation panel 13, the original document is read and image data are generated (step S201). For example, if processing modes corresponding to three types of image qualities of the original document, namely, photograph, text, and pencil are selectable on the operation panel 13, the image quality is changed to read the original document three times.

Next, respective data sizes (calculated values) are detected from the image data having been generated image-quality by image-quality (step S202), and for the respective image qualities, the data sizes and information indicating supposed loads for transfer of the respective image data are displayed on the operation panel 13, the loads corresponding to the respective data sizes (step S203).

FIG. 10 shows an example of a display screen 210 categorized by image quality, the screen being displayed on the operation panel 13. In the display screen 210 categorized by image quality, the types of image qualities, data sizes (calculated values), and information indicating supposed loads (loads on the network) for transfer of the respective image data are correspondingly displayed, the loads corresponding to the respective data sizes.

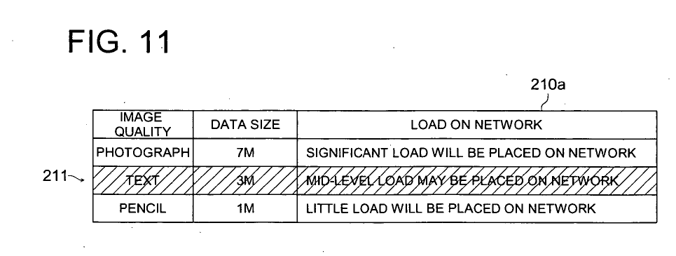

The user is prompted to select an image quality for transmission of an image data, with the display screen 210 categorized by image quality and displayed on the operation panel 13 as information for determination (FIG. 9, step S204). FIG. 11 shows an example of a display screen 210a categorized by image quality for the case where text is selected in FIG. 10. On this screen, the color in the display area 211 of a horizontal line corresponding to the selected image quality is changed. Upon receipt of an operation for selection of an image quality from the user, the image scanning apparatus 10 attaches image data read with the selected image quality to an E-mail and thereby transmits the image data (FIG. 9, step S205).

Next, “Scan to E-mail processing 2” will be described. In processing image signals obtained by the reader 11 in “Scan to E-mail processing 2”, selection of conditions relating to reading items is required in one case, while selection of conditions relating to output items is required in another one case. First, the case of changing reading conditions will be described.

In the case of selecting reading conditions, an image data is generated by reading the original document once with a reading condition selected for reading the original document, and then a calculated value is detected on a predetermined attribution (data size) of the image data. For other reading conditions, predetermined calculation is performed on the already obtained calculated value to obtain supposed values.

Items relating to the processing in reading the original document include resolution, compression method, and image quality, which will be respectively described below.

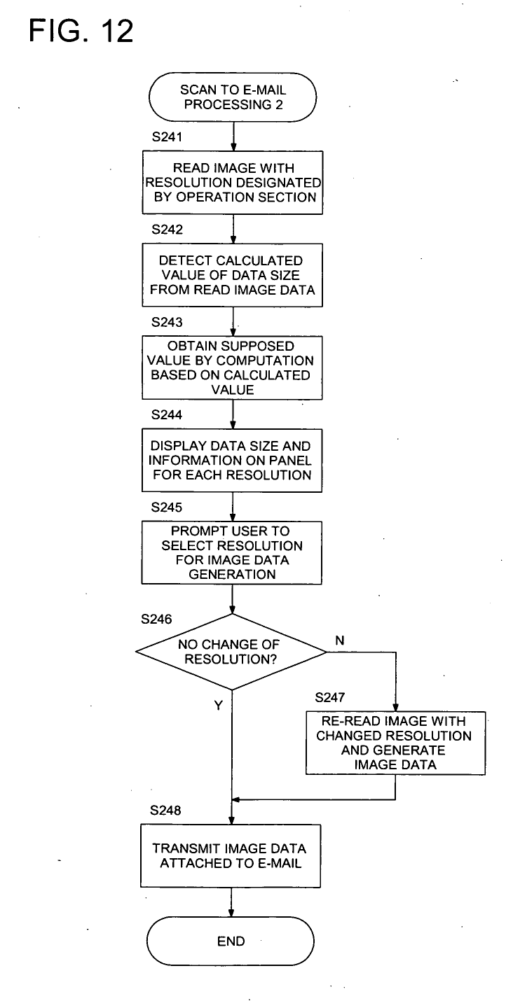

FIG. 12 shows the flow of “Scan to E-mail processing 2” for a case of changing resolution as a reading condition. Further, data flow in this processing is shown in FIG. 1. The original document is read with a resolution designated via the operation panel 13 to generate an image data (step S241 and P1 in FIG. 1) The data size (calculated value) of this image data is detected (step S242), and further from this calculated value, supposed values of data sizes with other resolutions are obtained by calculation (step S243).

For example, in a case where three resolutions of 600 dpi, 400 dpi, and 200 dpi are selectable via the operation panel 13 and the original document is actually read with the resolution of 400 dpi, supposed values of the data sizes for 600 dpi and 200 dpi are obtained by calculation. A supposed value is obtained by multiplying a calculated value by a preset weight coefficient.

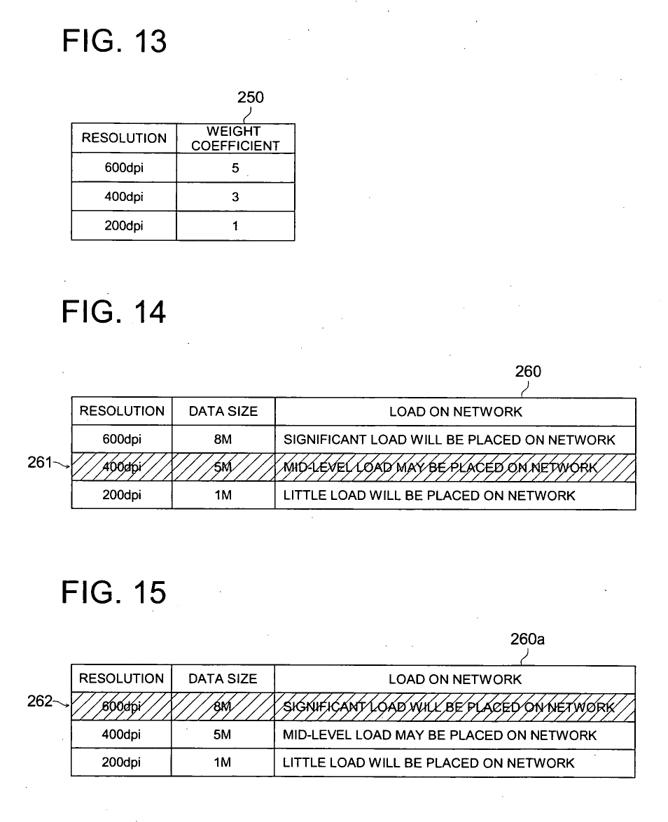

FIG. 13 shows an example of a weight coefficient table 250 categorized by resolution. In this example, a weight coefficient “5” for 600 dpi, a weight coefficient “3” for 400 dpi, and a weight coefficient “1” for 200 dpi are set. These values are obtained, for example, in such a manner that image data are read, changing resolution for various test charts, and the values of the weight coefficients are statistically determined from calculated values of the data sizes of these image data.

A supposed value is obtained as “supposed value=(calculated data size)/(weight coefficient of resolution corresponding to actual resolution)×(weight coefficient of resolution corresponding to supposed resolution)”. For example, if the resolution for reading the original document is 400 dpi and the calculated value of the data size is 3 MB, “supposed value for 600 dpi=3/3×5=5 MB”, referring to the weight coefficient table 250 categorized by resolution in FIG. 13, and “supposed value for 200 dpi=3/3×1=1 MB”.

Next, for each resolution, a resolution, a data size of a calculated value or a supposed value for the resolution, and information indicating a supposed load corresponding to the data size for transfer of image data are correspondingly displayed on the operation panel 13 (step S244). P2 in FIG. 1 shows a display designation of a calculated value/values and/or a supposed value/values.

FIG. 14 shows an example of the display screen 260 categorized by resolution, the screen being displayed on the operation panel 13. Here, the color of the display area 261 corresponding to a resolution (for a calculated value) selected at the time of reading the original document is arranged to have a different color from the other colors (for supposed values). For example, it is possible to display the area 261, highlighting black and white or changing the color of the background and texts.

Next, the user is prompted to select a resolution for transmission of image data, with the display screen 260 categorized by resolution and displayed on the operation panel 13 as information for determination (FIG. 12, step S245). P3 in FIG. 1 is a notification of the selection result to the processor 12.

If the selected resolution is different from that at the time of reading the original document (step S246; N), the original document is re-read with the resolution after change and an image data is generated (step S247 and P4 in FIG. 1), and this image data is attached to an E-mail to be transmitted (step S248 and P1 to P7 in FIG. 1).

FIG. 15 shows an example of a display screen 260a categorized by resolution for a case where a resolution is selected which is different from that applied to reading the original document, as shown in FIG. 14. On this screen, instead of the color of the display area corresponding to the resolution (400 dpi) applied at the first time of reading the original document, the color of the display area 262 for the later selected resolution (600 dpi) is made different from the color of the other display areas.

If the selected resolution and the resolution at the time of reading the original document (FIG. 12, step S246; Y), are the same, the image data read at the first time is attached to an E-mail to be transmitted (step S248).

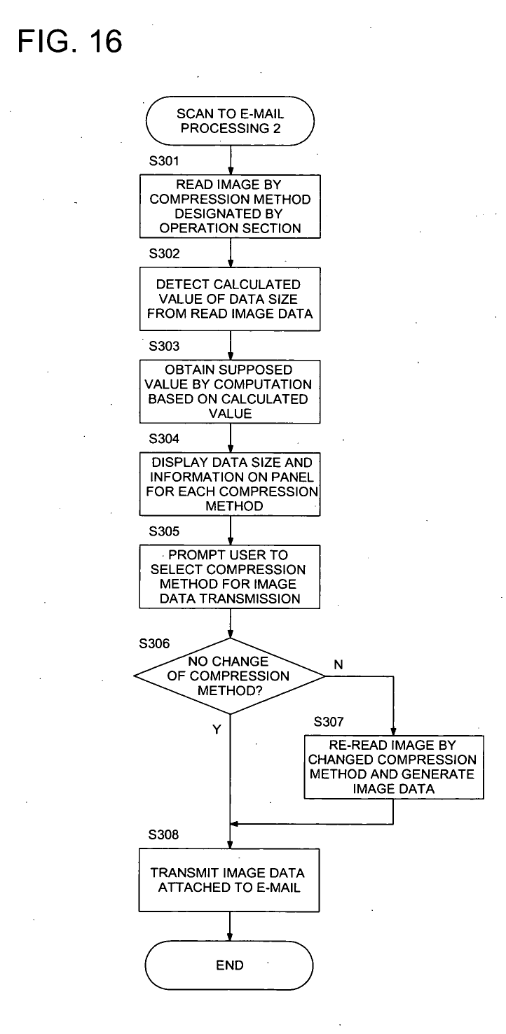

FIG. 16 shows the flow of “Scan to E-mail processing 2” in a case of changing compression method as a reading condition. The original document is read with a compression method designated via the operation panel 13 to generate an image data (step S301). The data size (calculated value) of this image data is detected (step S302), and further from this calculated value, supposed values of data sizes with other compression methods are obtained by calculation (step S303) For example, in a case where two types of compression methods, which are TIFF and PDF, are selectable via the operation panel 13 and the original document has been actually read by TIFF, a supposed value of the data size for PDF is obtained by calculation. A supposed value is obtained by multiplying a calculated value by a preset weight coefficient.

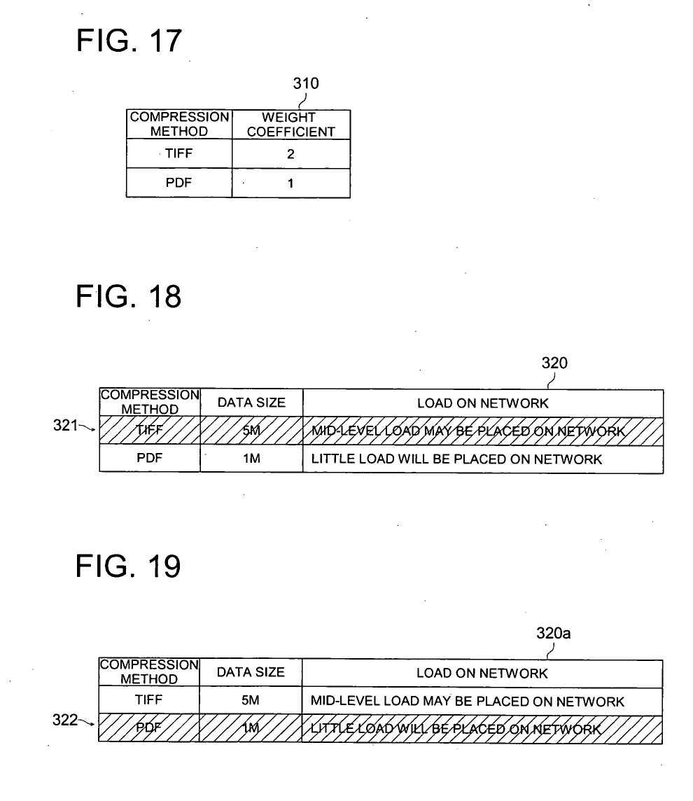

FIG. 17 shows an example of a weight coefficient table 310 categorized by compression method. In this example, a weight coefficient “2” for TIFF, and a weight coefficient “1” for PDF are set. These values are obtained, for example, in such a manner that image data are read, changing resolution method for various test charts, and the values of the weight coefficients are statistically determined from calculated values of the data sizes of these image data.

A supposed value is obtained as “supposed value=(calculated data size)/(weight coefficient of compression method corresponding to actual compression method)×(weight coefficient of compression method corresponding to supposed compression method)”. For example, if the compression method for reading the original document is TIFF and the calculated value of the data size is 5 MB, “supposed value for PDF=5/2×1=2.5 MB”, referring to the weight coefficient table 310 categorized by compression method in FIG. 17.

Next, for each compression method, a resolution, a data size of a calculated value or a supposed value for the resolution, and information indicating a supposed load corresponding to the data size for transfer of image data are correspondingly displayed on the operation panel 13 (step S304).

FIG. 18 shows an example of the display screen 320 categorized by compression method, the screen being displayed on the operation panel 13. Here, the color of the display area 321 corresponding to a compression method selected at the time of reading the original document is arranged to have a different color from the color of the other display area/areas. For example, it is possible to display the area, highlighting black and white or changing the color of the background and texts.

Next, the user is prompted to select a compression method for transmission of image data, with the display screen 320 categorized by compression method and displayed on the operation panel 13 as information for determination (FIG. 16, step S305). If the selected compression method is different from that at the time of reading the original document (step S306; N), the original document is re-read with the changed compression method and compressed to generate an image data (step S307), and this image data is attached to an E-mail to be transmitted (step S308).

FIG. 19 shows an example of a display screen 320a categorized by compression method for a case where a compression method is selected which is different from that, shown in FIG. 18, applied at the time of reading the original document. In this screen, instead of the color of the display area corresponding to the compression method (TIFF) applied at the first time of reading the original document, the color of the display area 322 for a later selected compression method (PDF) is made different from the color of the other display areas.

If the selected compression method and that applied at the time of reading the original document (FIG. 16, step S306; Y) are the same, the image data read at the first time is attached to an E-mail to be transmitted (step S308).

Incidentally, it is also possible that a raw data (image signals) is stored in a memory at the first time of reading the original document, and when the compression method is changed, an image data corresponding to the compression method after the change is generated from the raw data. In this case, reading operation of the original document is required only at the first time even if compression method is changed later, and thus the operating time is shortened. Further, it is not necessary to reset the original document on the automatic original document feeding device, improving the operationability.

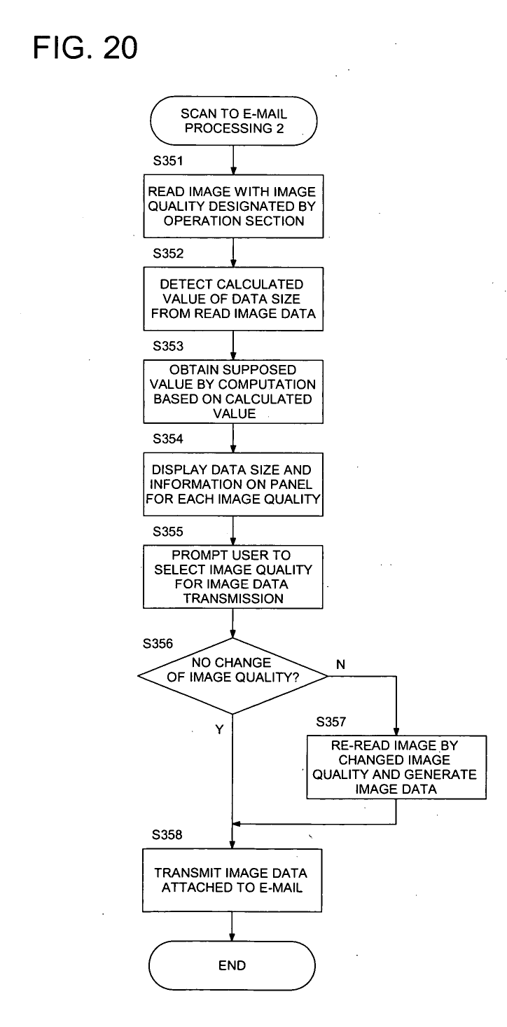

FIG. 20 shows the flow of “Scan to E-mail processing 2” in a case of changing image quality as a reading condition. The original document is read with an image quality designated via the operation panel 13 to generate an image data (step S351). The data size (calculated value) of this image data is detected (step S352), and further from this calculated value, supposed values of data sizes with other image qualities are obtained by calculation (step S353). For example, if three types of image qualities, which are photograph, text, and pencil are selectable via the operation panel 13 and the original document is actually read by photograph, the respective supposed values of the data sizes for text and pencil are obtained by calculation. A supposed value is obtained by multiplying a calculated value by a preset weight coefficient.

Next, for each image quality, a resolution, the data size of a calculated value or a supposed value for the resolution, and information indicating a supposed load corresponding to the data size for transfer of image data are correspondingly displayed on the operation panel 13 (step S354).

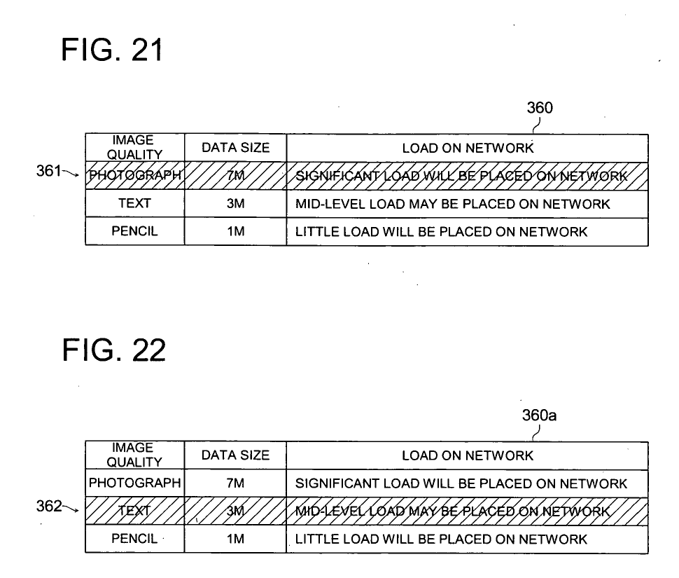

FIG. 21 shows an example of a display screen 360 categorized by image quality, the screen being displayed on the operation panel 13. Here, the color of the display area 361 corresponding to an image quality selected at the time of reading the original document is arranged to be different from that in the other display areas. For example, it is possible to display the area, highlighting black and white or changing the color of the background and texts.

Next, the user is prompted to select an image quality for transmission of image data, with the display screen 360 categorized by image quality and displayed on the operation panel 13 as information for determination (FIG. 20, step S355). If the selected image quality is different from that at the time of reading the original document (step S356; N), the original document is re-read with the changed image quality to generate an image data (step S357), and this image data is attached to an E-mail to be transmitted (step S358).

FIG. 22 shows an example of a display screen 360a categorized by image quality for a case where an image quality is selected which is different from that, shown in FIG. 21, applied at the time of reading the original document. On this screen, instead of the color of the display area corresponding to the image quality applied at the first time of reading the original document, the color of the display area 362 for a later selected image quality is made different from the color of the other display areas.

If the selected image quality and the image quality applied at the time of reading the original document are the same (FIG. 20, step S356; Y), the image data read at the first time is attached to an E-mail to be transmitted (step S358).

Next, a case of selecting conditions relating to output items will be described. In selection of output conditions, the calculated value of a data size is detected from a read image data, and for other output conditions, supposed values are obtained by performing calculation on the calculated value. The output items for output conditions include output sheet size in outputting, on the receiving side, the image data of the read original document being recorded on a designated recording sheet after forming an image. Such designation of output conditions is effective in a case where the transmitting side can designate an output size.

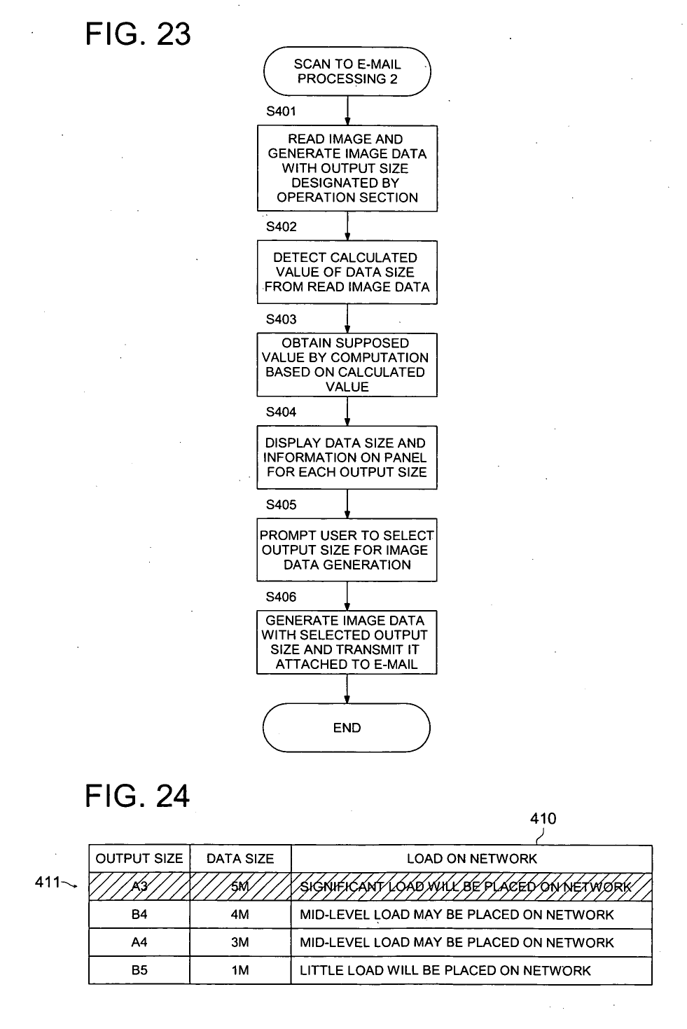

FIG. 23 shows the flow of “Scan to E-mail processing 2” in a case of changing the output size of the image data to be output on the receiving side, as an output condition. The original document is read and an image data which fits an output size designated via the operation panel 13 is generated (step S401). The data size (calculated value) of this image data is detected (step S402), and further from this calculated value, supposed values of data sizes of other output sizes are obtained by calculation (step S403). For example, in a case where four types of output sizes, namely A3, B4, A4, and B5, are selectable via the operation panel 13 and the designated output size at the time of reading the original document is A3, a data size (calculated value) for the output size A3 as the output condition is calculated based on the obtained image data, while supposed values of the data sizes for the output sizes of B4, A4, and B5 are obtained by calculation based on this calculated value. A supposed value is obtained by multiplying a calculated value by a preset weight coefficient.

Next, for each output size, an output size, a data size of a calculated value or a supposed value for the output size, and information indicating a supposed load corresponding to the data size for transfer of image data are correspondingly displayed on the operation panel 13 (step S404).

FIG. 24 shows an example of the display screen 410 categorized by output size, the screen being displayed on the operation panel 13. Here, the color of the display area 411 corresponding to the output size selected at the time of reading the original document is made different from the color in the other display areas. For example, it is possible to display the area, highlighting black and white or changing the color of the background and texts.

Next, the user is prompted to select an output size for transmission of image data, with the display screen 410 categorized by output size and displayed on the operation panel 13 as information for determination (FIG. 23, step S405). An image data is generated in the selected output size, and this image data is attached to an E-mail to be transmitted (step S406).

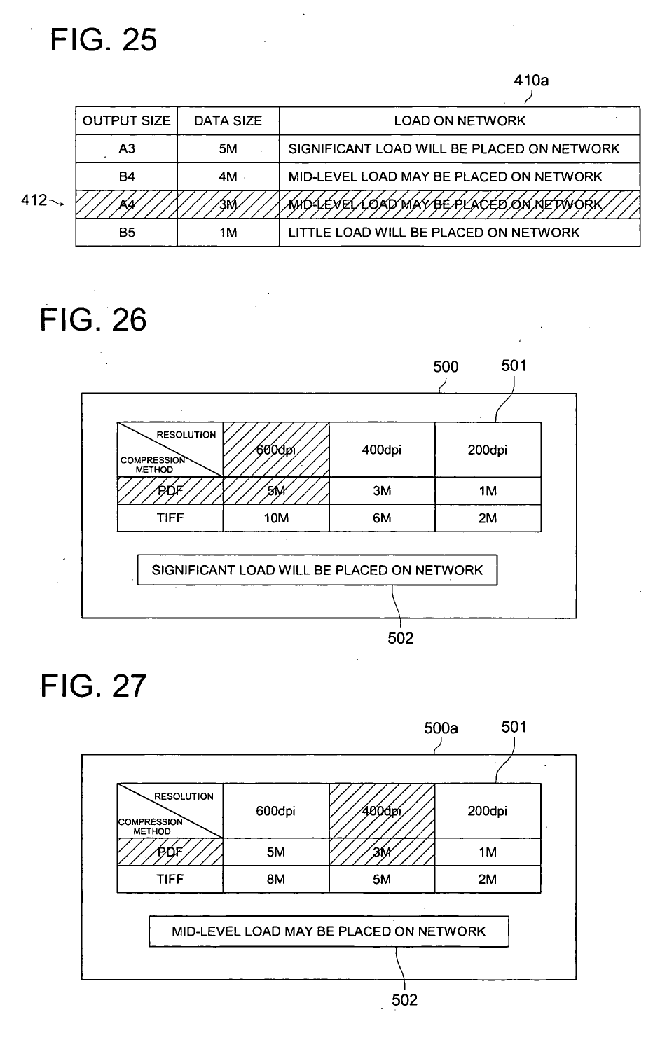

FIG. 25 shows an example of an display screen 410a categorized by output size for a case where an output size is selected which is different from that applied at the time of reading the original document. In this screen, instead of the display area corresponding to the first designated output size (A3), the color of the display area 412 for a later selected output size (A4) is made different from the color of the other display areas.

Next, a case of changing a plurality of reading conditions will be described. In the foregoing description, it has been described about cases of changing a processing condition of any one item for processing of image signals such as resolution, compression method, or image quality. However, it is also possible to select plural condition items and change processing conditions in the respective items, and display information relating to data sizes and transfer loads corresponding to the respective conditions. For example, in a case of changing reading conditions of two items, the operation may be arranged in such a manner that data sizes corresponding to combinations of parameters of the respective items are displayed in a matrix, then the user is prompted to select a combination in this matrix, and then transfer load information corresponding to the selected combination is displayed in a different display region.

FIG. 26 shows an example of a data display screen 500 for a case of changing reading conditions of two items, namely resolution and compression method. On the data display screen 500, a data size display region 501 and a load information display region 502 are provided. In the data size display region 501, a parameter in the row direction handles resolutions, while a parameter in the line direction handles compression methods, wherein a data size corresponding to a combination of a resolution and a compression method is displayed at the intersection of the line and the row on which the above resolution and the compression method are respectively displayed. The load information display region 502 is provided to display information on a transfer load corresponding to an image data of a selected combination.

In the example shown in FIG. 26, in the data size display region 501, a change is made on the color of the part corresponding to the combination of a resolution (6oo dpi) and a compression method (PDF) which have been set at the time of reading the original document, wherein the above changed color is different from that in the other parts. Since the data size corresponding to the above combination is 5 MB, a message “MID-LEVEL LOAD MAY BE PLACED ON NETWORK” is displayed in the load information display region 502.

FIG. 27 shows an example of a data display screen 500a in a case where the reading conditions are changed into a combination of the resolution 400 dpi and the compressive method PDF from the conditions displayed in FIG. 26. When the touch type operation panel 13 is to receive a selection operation by the user, the user may select respective parts (a position displaying a resolution value and a position displaying a compression method type) for respective conditions of processing items, or may select a part displaying a data size, thereby selecting processing conditions.

When selection is made, the color of the parts for the selected conditions of the respective items and the data size changes. The load information display region 502 displays transfer load information associated with the data size corresponding to the selected combination of resolution and compression method. Since the data size corresponding to the combination of resolution 400 dpi and compression method PDF is 3 MB, a message “MID-LEVEL LOAD MAY BE PLACED ON NETWORK” is displayed.

Incidentally, a supposed value in a case of changing a plurality of reading conditions is obtained as follows. In a case of changing resolution and compression method, “supposed value=(calculated data size)/(weight coefficient of resolution corresponding to actual resolution)×(weight coefficient of resolution corresponding to supposed resolution)/(weight coefficient of compression method corresponding to actual compression method)×(weight coefficient of compression method corresponding to supposed compression method)”.

For example, if the weight coefficient table 250 categorized by resolution in FIG. 13 and the weight coefficient table 310 categorized by compression method in FIG. 17 are used; the resolution used at the time of reading the original document is 400 dpi and the compression method used at the time of reading the original document is PDF; and the calculated value of data size is 3 MB, then a supposed value is calculated as follows.

Supposed value for resolution of 600 dpi and compression-method of PDF=3/3×5/1×1=5 MB. Supposed value for resolution of 200 dpi and compression-method of PDF=3/3×1/1×1=3 MB. Supposed value for resolution of 600 dpi and compression-method of TIFF=3/3×5/1×2=10 MB. Supposed value for resolution of 400 dpi and compression-method of TIFF=3/3×3/1×2=6 MB. Supposed value for resolution of 200 dpi and compression-method of TIFF=3/3×1/1×2=2 MB.

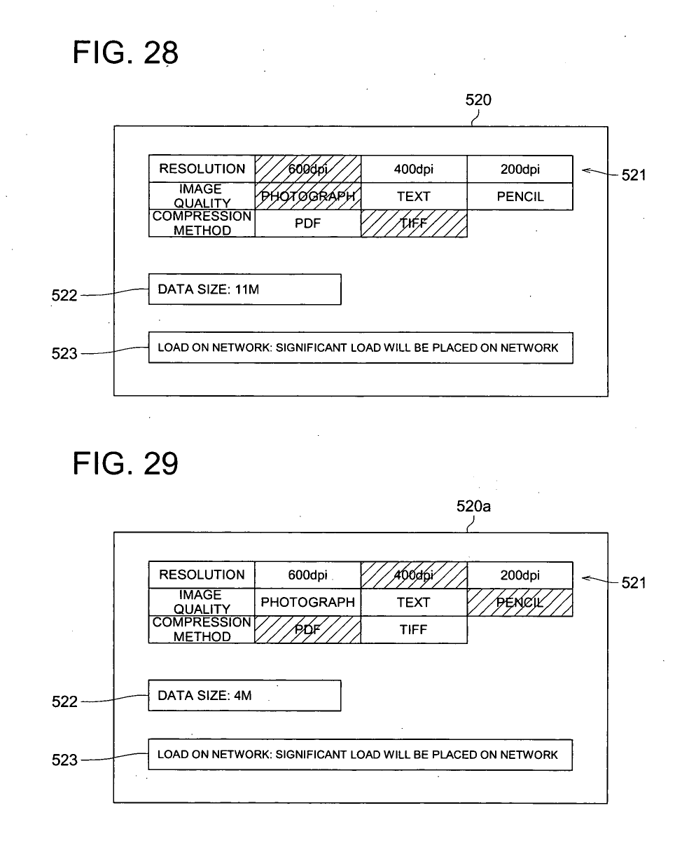

FIG. 28 shows an example of a data display screen 520 in a case where there are three reading condition items. If there are more than two items, the conditions and data sizes cannot be displayed together by a single matrix. Therefore, there are provided a condition selection area 521 for selection of a condition, a data size area 522 for displaying a data size corresponding to a combination of selected conditions, and an information area 523 for displaying a transfer load information corresponding to the selected conditions.

FIG. 28 shows a data display screen 520 displayed in a case where the original document is read with selection of the resolution of 600 dpi, the image quality of photograph, and the compression-method of TIFF, wherein the color of the corresponding positions (600 dpi, photograph, TIFF) in the condition selection area 521 is changed.

FIG. 29 shows an example of a data display screen 520a in a case where the reading conditions are changed from the conditions in FIG. 28 to the conditions of the resolution of 400 dpi, the image quality of pencil, and the compression method of PDF. By touching a position where a value of an item is displayed in the data size area 522, the user can change the current value of the item to the value of the touched position described above.

In a case of obtaining a supposed value, a supposed value corresponding to a selected combination is obtained by calculation, and then the value is displayed in the data size area 522. In a case of calculated values, although the calculated values may be obtained by reading the original document for all combinations in advance, the original document also may be re-read with conditions corresponding to a new combination each time combination is changed. Of course, in a case where the conditions, with which the original document has been already read, are selected again, it is not necessary to re-read the original document. If the number of condition items is increased, the number of combinations becomes large. Therefore, rather than obtaining calculated values for all conditions, the original document is preferably re-read, with newly selected conditions each time a condition/conditions are changed.

The data size area 522 displays a supposed value or a calculated value of a data size with conditions of the resolution of 400 dpi, the image quality of pencil, and the compression method of PDF. The information area 523 displays transfer load information corresponding to the data size displayed in the data size area 522.

Although an embodiment of the invention has been described above, referring to the drawings, concrete structures are not limited to the structure shown in the present embodiment, and the invention includes modification and addition within a scope which does not deviate from the gist of the invention.

In the present embodiment, a supposed value is obtained from a calculated value by the use of a weight coefficient. However, calculation methods for supposed values are not limited to this. For example, a supposed value also can be obtained from a calculated value by using a function approximating the relationship between calculated values and suppose values, or by preparing a table showing the corresponding relationship between calculated values and supposed values and referring to this table. Further, a supposed value may also be obtained, not from a calculated value, but based on an image data obtained by reading the original document.

In the present embodiment, calculated values and/or supposed values are obtained for all selectable conditions, changing reading conditions and output conditions. However, it is also allowed to obtain attribution values, not for all selectable conditions of an arbitrary processing item, but for a partial plurality of them. For example, calculated values and/or supposed values may be obtained only for cases where data sizes of image data obtained by changing processing conditions are smaller than the data size of an image obtained with designated reading conditions and output conditions (for example, the data size of an image data obtained by first reading).

Further, it is also possible to transmit image data in such a manner that only one image data is obtained; only one attribution value is obtained; both processing conditions and added information are displayed; and the user confirms whether the one image data may be transmitted as it is, or a new image data is to be transmitted after changing a processing condition.

It is also possible to change a reading condition and/or output condition, and obtain and display a changed calculated value and/or a supposed value, only when a data size of an image data obtained by reading the original document at the first time will place a significant load on the network or may place a mid-level load on the network. Preferably, it is possible to define cases where conditions are to be changed to obtain calculated values and supported values.

Further, a method for obtaining a calculated value with a change of reading conditions from those of a stored raw data is not limited to be applied to a case of changing compression method, but may be applied to changes of other conditions, if possible.

What is claimed is:

1. An image scanning apparatus comprising:
a reader which reads an original document in accordance with a first reading condition and generates a first image data corresponding to the original document;
a processor which calculates a first calculated value relating to a first attribution of the first image data and a second supposed value based on a second reading condition different from the first reading condition and one of the first image data and the first calculated value, wherein the second supposed value relates to a second attribution, and the second attribution relates to a second image data which are generated in case the original document is read in accordance with the second reading condition; and
a display which displays the first calculated value and the second supposed value.

2. The image scanning apparatus of claim 1, further comprising:
a selector which selects one of the first reading condition and the second reading condition in accordance with a user operation after displaying the first calculated value and the second supposed value.

3. The image scanning apparatus of claim 2, wherein the original document is actually read in accordance with the second reading condition so as to generate the second image data, when the selector selects the second reading condition.

4. The image scanning apparatus of claim 3, further comprising:
a transmitting section which transmits one of the first image data and the second image data in accordance with one of the first reading condition and the second reading condition selected by the selector.

5. The image scanning apparatus of claim 4, wherein the display further displays information with regard to a network load in case the transmitting section transmits the first image data and the second image data.

6. The image scanning apparatus of claim 1, wherein the first attribution and the second attribution include a data size of the first image data and a data size of the second image data, respectively.

7. The image scanning apparatus of claim 1, wherein the first reading condition and the second reading condition include a condition for a resolution in an image reading process.

8. The image scanning apparatus of claim 1, wherein the first reading condition and the second reading condition include a condition for a type of data compression.

9. The image scanning apparatus of claim 1, wherein the first reading condition and the second reading condition include a condition for an image quality of the original document.

10. An image scanning apparatus comprising:
a reader which reads an original document in accordance with a first reading condition and a second reading condition different from the first reading condition, and generates a first image data and a second image data corresponding to the original document, respectively;
a processor which calculates a first calculated value relating to a first attribution of the first image data and a second calculated value relating to a second attribution of the second image data; and
a display which displays the first calculated value and the second calculated value.

11. The image scanning apparatus of claim 10, further comprising:
a selector which selects one of the first reading condition and the second reading condition in accordance with a user operation after displaying the first calculated value and the second supposed value.

12. The image scanning apparatus of claim 11, further comprising:
a transmitting section which transmits one of the first image data and the second image data in accordance with one of the first reading condition and the second reading condition selected by the selector.

13. The image scanning apparatus of claim 12, wherein the display further displays information with regard to a network load in case the transmitting section transmits the first image data and the second image data.

14. The image scanning apparatus of claim 10, wherein the first attribution and the second attribution include a data size of the first image data and a data size of the second image data, respectively.

15. The image scanning apparatus of claim 10, wherein the first reading condition and the second reading condition include a condition for a resolution in an image reading process.

16. The image scanning apparatus of claim 10, wherein the first reading condition and the second reading condition include a condition for a type of data compression.

17. The image scanning apparatus of claim 10, wherein the first reading condition and the second reading condition include a condition for an image quality of the original document.

18. An image scanning apparatus comprising:
a reader which reads an original document in accordance with a reading condition and a first output condition, and generates a first image data corresponding to the original document;
a processor which calculates a first calculated value relating to a first attribution of the first image data and a second supposed value based on a second output condition different from the first output condition and one of the first image data and the first calculated value, wherein the second supposed value relates to a second attribution, and the second attribution relates to a second image data which are generated in case the original document is read in accordance with the second output condition; and
a display which displays the first calculated value and the second supposed value.

19. The image scanning apparatus of claim 18, further comprising:
a selector which selects one of the first reading condition and the second reading condition in accordance with a user operation after displaying the first calculated value and the second supposed value.

20. The image scanning apparatus of claim 19, wherein the original document is actually read in accordance with the second output condition so as to generate the second image data, when the selector selects the second supposed value.

21. The image scanning apparatus of claim 20, further comprising:
a transmitting section which transmits one of the first image data and the second image data in accordance with one of the first reading condition and the second reading condition selected by the selector.

22. The image scanning apparatus of claim 21, wherein the display further displays information with regard to a network load in case the transmitting section transmits the first image data and the second image data.

23. The image scanning apparatus of claim 18, wherein the first attribution and the second attribution include a data size of the first image data and a data size of the second image data, respectively.

24. The image scanning apparatus of claim 18, wherein the first reading condition includes a condition for a resolution in an image reading process.

25. The image scanning apparatus of claim 18, wherein the first reading condition includes a condition for a type of data compression.

26. The image scanning apparatus of claim 18, wherein the first reading condition includes a condition for an image quality of the original document.

27. The image scanning apparatus of claim 18, wherein the first output condition and the second output condition include a condition for a size of a recording sheet on which an image is recorded based on the image data.

28. An image scanning apparatus comprising:
a reader which reads an original document and generates an image signals corresponding to the original document;
an image processing condition setting section which is selectable for one of a first processing condition and a second processing condition;
a processor which generates a first image data by processing the image signals in accordance with the first processing condition, and calculates a first calculated attribution value based on the first image data; and
a display which displays the first calculated attribution value.

29. The image scanning apparatus of claim 28, wherein the processor generates a second image data by processing the image signals in accordance with the second processing condition and calculates a second calculated attribution value based on the second image data, and the display further displays the second calculated attribution value.

30. The image scanning apparatus of claim 29, further comprising:
a selector which selects one of the first processing condition and the second processing condition in accordance with a user operation after displaying the first calculated attribution value and the second calculated attribution value.

31. The image scanning apparatus of claim 30, further comprising:
an operation panel which allows user operations for the image scanning apparatus;
wherein the display and the selector are provided on the operation panel.

32. The image scanning apparatus of claim 31, wherein the image processing condition setting section is provided on the operation panel.

33. The image scanning apparatus of claim 30, further comprising:
a transmitting section which transmits one of the first image data and the second image data obtained in accordance with one of the first processing condition and the second processing condition selected by the selector.

34. The image scanning apparatus of claim 33, wherein the display further displays a first network load information and a second network load information according to a comparison the first calculated attribution value corresponding to the first image data and the second calculated attribution value corresponding to the second image data with a predetermined value, respectively, and wherein the first network load information and the second network load information relate to a network load in case the transmitting section transmits each the first image data and the second image data.

35. The image scanning apparatus of claim 34, wherein the display connectedly displays the first and the second attribution values, the first and the second processing conditions, and the first and the second network load information, respectively.

36. The image scanning apparatus of claim 33, wherein the original document is actually read in accordance with the second processing condition so as to generate the second image data, after the original document is read in accordance with the first processing condition.

37. The image scanning apparatus of claim 28, wherein the processor calculates a second supposed attribution value based on the second processing condition and the first calculated attribution value, the second supposed attribution value relates to a second attribution, the second attribution relates to a second image data which are generated in case the original document is processed in accordance with the second processing condition, and the display further displays the second supposed attribution value.

38. The image scanning apparatus of claim 37, further comprising:
a selector which selects one of the first processing condition and the second processing condition in accordance with a user operation after displaying the first calculated attribution value and the second supposed attribution value.

39. The image scanning apparatus of claim 38, further comprising:
an operation panel which allows user operations for the image scanning apparatus;
wherein the display and the selector are provided on the operation panel.

40. The image scanning apparatus of claim 39, wherein the image processing condition setting section is provided on the operation panel.

41. The image scanning apparatus of claim 38, further comprising:
a transmitting section which transmits one of the first image data and the second image data obtained in accordance with one of the first processing condition and the second processing condition selected by the selector.

42. The image scanning apparatus of claim 41, wherein the display further displays a first network load information and a second network load information according to a comparison the first calculated attribution value corresponding to the first image data and the second supposed attribution value corresponding to the second image data with a predetermined value, respectively, and wherein the first network load information and the second network load information relate to a network load in case the transmitting section transmits each the first image data and the second image data.

43. The image scanning apparatus of claim 42, wherein the display connectedly displays the first and the second attribution values, the first and the second processing conditions, and the first and the second network load information, respectively.

44. The image scanning apparatus of claim 28, wherein the processor calculates a second supposed attribution value based on the second processing condition and the first image data, the second supposed attribution value relates to a second attribution, the second attribution relates to a second image data which are generated in case the original document is processed in accordance with the second processing condition, and the display further displays the second supposed attribution value.

45. The image scanning apparatus of claim 44, further comprising:
a selector which selects one of the first processing condition and the second processing condition in accordance with a user operation after displaying the first calculated attribution value and the second supposed attribution value.

46. The image scanning apparatus of claim 45, further comprising:
an operation panel which allows user operations for the image scanning apparatus;
wherein the display and the selector are provided on the operation panel.

47. The image scanning apparatus of claim 46, wherein the image processing condition setting section is provided on the operation panel.

48. The image scanning apparatus of claim 45, further comprising:
a transmitting section which transmits one of the first image data and the second image data obtained in accordance with one of the first processing condition and the second processing condition selected by the selector.

49. The image scanning apparatus of claim 48, wherein the display further displays a first network load information and a second network load information according to a comparison the first calculated attribution value corresponding to the first image data and the second supposed attribution value corresponding to the second image data with a predetermined value, respectively, and wherein the first network load information and the second network load information relate to a network load in case the transmitting section transmits each the first image data and the second image data.

50. The image scanning apparatus of claim 49, wherein the display connectedly displays the first and the second attribution values, the first and the second processing conditions, and the first and the second network load information, respectively.

51. The image scanning apparatus of claim 28, further comprising:
a transmitting section which transmits the first image data,
wherein the display displays the first calculated attribution value for determining whether the first image data are allowed to be transmitted or not before transmitting the first image data.

52. The image scanning apparatus of claim 28, wherein the processor includes an image processing section which obtains the first image data by processing the image signals in accordance with the first processing condition, and an attribution calculating section which obtains the first calculated attribution value based on the first image data.

53. The image scanning apparatus of claim 29, wherein the first processing condition and the second processing condition include a condition for a resolution.

54. The image scanning apparatus of claim 37, wherein the first processing condition and the second processing condition include a condition for a resolution.

55. The image scanning apparatus of claim 44, wherein the first processing condition and the second processing condition include a condition for a resolution.

56. The image scanning apparatus of claim 29, wherein the first processing condition and the second processing condition include a condition for a type of data compression.

57. The image scanning apparatus of claim 37, wherein the first processing condition and the second processing condition include a condition for a type of data compression.

58. The image scanning apparatus of claim 44, wherein the first processing condition and the second processing condition include a condition for a type of data compression.

59. The image scanning apparatus of claim 29, wherein the first processing condition and the second processing condition include a condition for an image quality of the original document.

60. The image scanning apparatus of claim 37, wherein the first processing condition and the second processing condition include a condition for an image quality of the original document.

61. The image scanning apparatus of claim 44, wherein the first processing condition and the second processing condition include a condition for an image quality of the original document.

62. The image scanning apparatus of claim 29, wherein the first processing condition and the second processing condition include a condition for a size of a recording sheet on which an image is recorded based on the first image data and the second image data.

63. The image scanning apparatus of claim 37, wherein the first processing condition and the second processing condition include a condition for a size of a recording sheet on which an image is recorded based on the first image data and the second image data.

64. The image scanning apparatus of claim 44, wherein the first processing condition and the second processing condition include a condition for a size of a recording sheet on which an image is recorded based on the first image data and the second image data.

65. The image scanning apparatus of claim 29, wherein the first calculated attribution value and the second attribution value include a data size of the first image data and a data size of the second image data, respectively.

66. The image scanning apparatus of claim 37, wherein the first calculated attribution value and the second attribution value include a data size of the first image data and a data size of the second image data, respectively.

67. The image scanning apparatus of claim 44, wherein the first calculated attribution value and the second-attribution value include a data size of the first image data and a data size of the second image data, respectively.

68. An image scanning system, comprising:
an image scanning apparatus; and
a computer electrically connected with the image scanning apparatus,
wherein the image scanning apparatus includes
a reader which reads an original document and generates an image signals corresponding to the original document, and
a processor which generates a first image data by processing the image signals in accordance with a first processing condition, and calculates a first calculated attribution value based on the first image data, and wherein the computer includes
a display which displays the first calculated attribution value.

69. The image scanning system of claim 68, wherein the processor generates a second image data by processing the image signals in accordance with a second processing condition and calculates a second calculated attribution value based on the second image data, and the display further displays the second calculated attribution value.

70. The image scanning system of claim 69, wherein the computer includes
a selector which selects one of the first processing condition and the second processing condition in accordance with a user operation after displaying the first calculated attribution value and the second calculated attribution value.

71. The image scanning system of claim 70, further comprising:
a transmitting section which transmits one of the first image data and the second image data obtained in accordance with one of the first processing condition and the second processing condition selected by the selector.

72. The image scanning system of claim 71, wherein the display further displays a first network load information and a second network load information according to a comparison the first calculated attribution value corresponding to the first image data and the second calculated attribution value corresponding to the second image data with a predetermined value, respectively, and wherein the first network load information and the second network load information relate to a network load in case the transmitting section transmits each the first image data and the second image data.

73. The image scanning system of claim 72, wherein the display connectedly displays the first and the second attribution values, the first and the second processing conditions, and the first and the second network load information, respectively.

74. The image scanning system of claim 71, wherein the original document is actually read in accordance with the second processing condition so as to generate the second image data, after the original document is read in accordance with the first processing condition.

75. The image scanning system of claim 68, wherein the processor calculates a second supposed attribution value based on the second processing condition and the first calculated attribution value, the second supposed attribution value relates to a second attribution, the second attribution relates to a second image data which are generated in case the original document is processed in accordance with the second processing condition, and the display further displays the second supposed attribution value.

76. The image scanning system of claim 75, wherein the computer includes
a selector which selects one of the first processing condition and the second processing condition in accordance with a user operation after displaying the first calculated attribution value and the second supposed attribution value.

77. The image scanning system of claim 76, further comprising:
a transmitting section which transmits one of the first image data and the second image data obtained in accordance with one of the first processing condition and the second processing condition selected by the selector.

78. The image scanning system of claim 77, wherein the display further displays a first network load information and a second network load information according to a comparison the first calculated attribution value corresponding to the first image data and the second supposed attribution value corresponding to the second image data with a predetermined value, respectively, and wherein the first network load information and the second network load information relate to a network load in case the transmitting section transmits each the first image data and the second image data.

79. The image scanning system of claim 78, wherein the display connectedly displays the first and the second attribution values, the first and the second processing conditions, and the first and the second network load information, respectively.

80. The image scanning system of claim 68, wherein the processor calculates a second supposed attribution value based on the second processing condition and the first image data, the second supposed attribution value relates to a second attribution, the second attribution relates to a second image data which are generated in case the original document is processed in accordance with the second processing condition, and the display further displays the second supposed attribution value.

81. The image scanning system of claim 80, wherein the computer includes
a selector which selects one of the first processing condition and the second processing condition in accordance with a user operation after displaying the first calculated attribution value and the second supposed attribution value.

82. The image scanning system of claim 81, further comprising:
a transmitting section which transmits one of the first image data and the second image data obtained in accordance with one of the first processing condition and the second processing condition selected by the selector.

83. The image scanning system of claim 82, wherein the display further displays a first network load information and a second network load information according to a comparison the first calculated attribution value corresponding to the first image data and the second supposed attribution value corresponding to the second image data with a predetermined value, respectively, and wherein the first network load information and the second network load information relate to a network load in case the transmitting section transmits each the first image data and the second image data.

84. The image scanning system of claim 83, wherein the display connectedly displays the first and the second attribution values, the first and the second processing conditions, and the first and the second network load information, respectively.

85. The image scanning system of claim 68, further comprising:
a transmitting section which transmits the first image data,
wherein the display displays the first calculated attribution value for determining whether the first image data are allowed to be transmitted or not before transmitting the first image data.

86. The image scanning system of claim 68, wherein the processor includes an image processing section which obtains the first image data by processing the image signals in accordance with the first processing condition, and an attribution calculation section which obtains the first calculated attribution value based on the first image data.
